(19) United States
(12) Patent Application Publication
(10) Pub. No.: US 2026/0252283 A1
(43) Pub. Date: Aug. 27, 2026

(54) PRINTER MANAGEMENT TOOL

(71) Applicant: FMR LLC, Boston, MA (US)

(72) Inventors: Palavalli Govindaraju Raghunandan, Bangalore (IN); Syed Muzamil, Bengaluru Karnataka (IN)

(21) Appl. No.: 19/063,443

(22) Filed: Feb. 26, 2025

(51) Int. Cl. G06F 3/12; B41J 29/00; G06F 40/30

(52) U.S. Cl. CPC G06F 3/1219; G06F 3/1256; G06F 3/1268; B41J 29/00; G06F 40/30

(57) ABSTRACT

A computerized method is provided for print system management in large organizations. Print metadata is intercepted and diverted upon receipt of print instructions across any application within an organization. The user is prompted to provide a justification for the print job to encourage thoughtfulness and resource conservation as well as providing usable data on print job characteristics for subsequent analysis. The prompt can be located by the system across multi monitor environments and remote desktops. Upon receipt of a justification, the print metadata can be returned to the expected location to allow the print job to continue.

### TECHNICAL FIELD

This application relates generally to systems, methods, and apparatuses, including computer program products, for managing print requests including implementation of green initiatives and print justification protocols.

### BACKGROUND

Paper printing, especially in large organizations, can have a significant environmental impact as well as a marked impact on costs including in consumables (e.g., paper and ink), hardware (e.g., printers), and waste-related costs for disposal or recycling of printed items. While some print jobs will remain necessary, an organization can derive measurable benefits from discouraging unnecessary or excess printing by its employees.

Thoughtful reminders in e-mails or other documents to consider whether the item needs to be printed can help but are often ignored. More significant or intrusive efforts run the risk of alienating or upsetting employees, or interfering with their efficiency which can be counterproductive to the organization's goals in implementing a print-reduction strategy.

### SUMMARY

Systems and methods of the invention provide an effective tool for managing print jobs including interrupting the print process while additional input is received from a user. In various instances, a print justification can be required wherein the user, upon selecting to print an item, may be presented with a prompt to provide a justification or reason for printing. The justification may be selected from a drop down menu of approved reasons or otherwise entered by the user. The process may cause the user to stop and think about whether the print job is necessary without significantly interfering with their work.

In response to the challenge of managing high-volume printing demands across diverse user devices and applications, the systems and methods described herein mark a significant improvement in the existing technology of print job management, in many instances improving the functioning of the computer and printer itself. By leveraging, for example, a customized C# message box, systems and methods of the invention seamlessly monitor and prompt users to justify print jobs before release. This solution, adaptable across various platforms and multi-monitor scenarios, ensures that regardless of the device or application, users are prompted to provide justifications for each print job. By enhancing visibility and control over print activities, systems and methods herein can optimize resource allocation and empower informed decision-making, alleviating the burden of print distribution imbalances across branches. For example, justifications can be saved and reviewed or summarized for review in order to identify areas of inefficiencies that might be addressed to reduce the print requirements of the organization.

In various embodiments, when a user prints a document, associated metadata is created. This metadata can be in any file format or location on the local file system and may even be encrypted. Systems and methods of the invention can monitor the parent folders for any newly created subfolder consisting of print metadata. In some embodiments, a daemon service can monitor a print folder for the creation of any subfolder therein indicative of a new print job. Print instructions can also be sent to print servers, a network, the cloud, or other print infrastructure about the print job. Upon identifying the creation of pint metadata, that metadata can be moved by systems and methods of the invention to another location other than the anticipated folder/location (either locally or file share). A popup a message box for print justification can then be displayed, seeking a justification to select from dropdown. Systems and methods herein can identify the location of the program user interface from which the print job has been requested and display the popup message box on or near that display location. This functionality can be particularly advantageous in a multi-monitor environment or in a remote desktop environment.

Upon submitting the justification, systems and methods herein can then enable the print job by returning the print metadata to its original location where the print utility will anticipate it so that the print job can continue. If a user does not provide the justification or chooses to cancel the print request, systems and methods of the invention can discard the diverted print metadata and clear the print job sent to the printer. In various embodiments, one justification may be required for each print job or a single justification may be applied to multiple print jobs.

In certain embodiments, an Extensible Application Markup Language (XAML) user interface can be used to intercept print job requests across diverse endpoints and applications, prompting users for immediate justifications pre-release of print job. This system can seamlessly adapt to multi-monitor environments, ensuring the prompt appears on the user's active screen, irrespective of their workspace configuration. Visibility of the pop-up can be maintained across all screens and active windows even within hosted virtual desktop (HVD) sessions.

In some embodiments, enhanced user messaging can be derived through natural language and sentiment analysis. Systems and methods of the invention can offer real-time feedback on the environmental impact of printing decisions and can establish a continuous feedback loop for ongoing improvement based on user input. User input can also be used to encourage fellow colleagues to avoid printing and explore other alternatives via automated messaging. The user justification inputs can be stored in a centralized database for analysis and the systems and methods herein can generates online reports and dashboards on demand to visualize and analyze print consumption/reduction stats.

Aspects of the invention can include a computerized method for print management comprising the steps of: receiving, from a client computing device, an electronic print request comprising print metadata from a user; withholding the print metadata from a printer; requesting, from the client computing device, a justification for the print request; receiving, from the client computing device, the requested justification; and releasing the print metadata to the printer to initiate printing of the print request after receiving the requested justification. The requesting step can include displaying a prompt on the user's computer monitor. Methods may further include detecting an active monitor in a multi-monitor environment of the user and displaying the prompt on the active monitor.

In some embodiments, the multi-monitor environment can include a hosted virtual desktop (HVD) session further comprising displaying the prompt within in the HVD session. The prompt can comprise a list of pre-filled justifications for the user to select. In certain embodiments, the prompt can further comprise a request for feedback from the user, with the method further including receiving feedback from the user and analyzing the received feedback with natural language processing to assign a sentiment to the received feedback selected from positive, negative, or neutral. In various embodiments, the prompt can further comprise a promotional message identifying a second user that has shared positive feedback.

Methods of the invention may further comprise identifying the second user based on an organizational relationship with the user. The received feedback can be assigned a negative sentiment, the method further comprising pausing justification requests of the user for a selected number of print requests received from the user.

Aspects of the invention can include computer systems for print management. Systems can include a processor in communication with a non-transient memory and operable to perform the steps of receiving, from a client computing device, a print request comprising print metadata from a user; withholding the print metadata from a printer; requesting, from the client computing device, a justification for the print request; receiving, from the client computing device, the requested justification; and releasing the print metadata to the printer to initiate printing of the print request after receiving the requested justification.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for print management.

FIG. 2 shows an exemplary method for print management.

FIG. 3 shows a sample user prompt with encouraging messaging.

FIG. 4 shows a sample user prompt with binary feedback.

FIG. 5 shows a sample user prompt with text feedback selection.

FIG. 6 shows a sample user prompt with user-specific encouragement feedback from peers displayed.

FIG. 7 shows an exemplary flow chart of methods of the invention according to certain embodiments.

### DETAILED DESCRIPTION

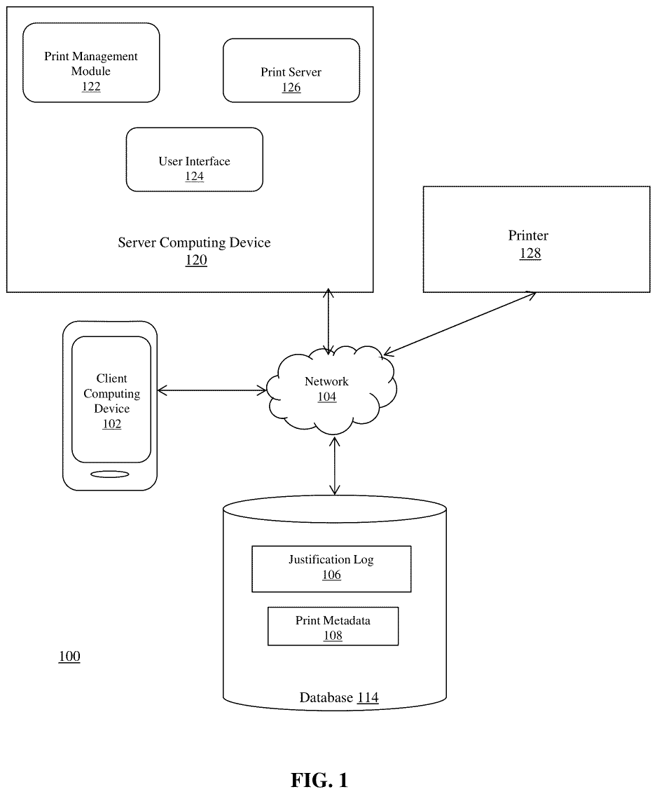

FIG. 1 is a block diagram of an exemplary system 100 for print management. The system 100 includes a client computing device 102, a communications network 104, a server computing device 120 that includes a print management module 122, a user interface 124, and a print server 126. The system 100 also includes a database 114 for storing print justifications 106 and diverted print metadata 108. A printer 128, controlled by the print server 126 is in communication with the client computing device 102, the server computing device 120, and/or the database 114 via the network 104.

The client computing device 102 connects to one or more communications networks (e.g., network 104) in order to communicate with the server computing device 120 to provide input and receive output relating to print jobs. A user may request to print a document or other item through the client computing device 102 from any print-capable application that may be running on the client computing device 102, a web or mobile application, and/or the server computing device 120. The print management module 122 can identify the print request and automatically divert print metadata associated with the print job to a selected location (i.e. a print metadata storage location 114). The print server 126, which will have received the print request and manages print jobs for the printer 128 will look for the print metadata in an anticipated location in order to initiate the printing process. However, the diverted print metadata will not be found in the anticipated location and the print job will therefore be held.

A user interface 124 running on the server computing device 120 or the client computing device 102 as part of the print management module 122 can prompt the user for a print justification via an input/output device on the client computing device 102. The print management module 122 and/or the user interface 124 can be configured to collocate the prompt with the display of the application from which the print request was initiated. Accordingly, the prompt will appear at the location where the user's attention is anticipated to be directed, even across multiple monitors and/or remote desktop applications.

When the user enters a justification through the user interface 124, the print management module 122 can record the justification in the justification log 106 for later review, summary, and/or analysis. The print management module 122 can also then return the print metadata from the print metadata storage location 114 to the anticipated folder or location from which the print server 126 can locate it and continue the print job.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used in conjunction with applications or modules on the server computing device 120. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., initiate print requests or review print justification summaries). Generally, a browser application comprises software executing on a processor of the client computing device 102 that enables the client computing device to communicate via HTTP or HTTPS with remote servers addressable with URLs (e.g., server computing device 120) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 120 and the database 114 in certain embodiments. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions. As discussed above the server computing device 120 includes a print management module 122, a user interface 124, and a print server 126 along with any number of other programs that may execute on the processor of the server computing device 120 and may each, despite being disparate programs, rely on a regular exchange of data between them and/or the database 114.

In some embodiments, the various modules, programs, or applications are specialized sets of computer software instructions programmed onto one or more dedicated processors in the server computing device 120 and can include specifically designated memory locations and/or registers for executing the specialized computer software instructions.

Although the applications and modules are shown in FIG. 1 as executing within the same server computing device 120, in some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

The database 114 is a computing device (or in some embodiments, a set of computing devices) coupled to the server computing device 120 and is configured to receive, generate, and store specific segments of data relating to printer management. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

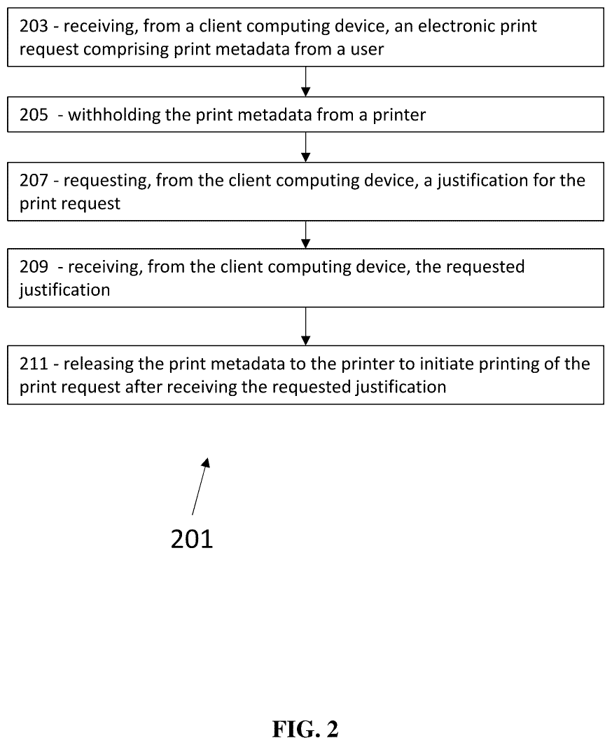

FIG. 2 shows an exemplary method 201 for print management, Steps can include receiving 203, from a client computing device, an electronic print request comprising print metadata from a user. The print metadata can then be withheld 205 from a printer while a justification for the print request is requested 207 from the client computing device. The requested justification can be received 209 from the client computing device and the print metadata can then be released 211 to the printer to initiate printing of the print request.

While described herein with respect to print justifications as a cost reduction and/or environmental initiative, the systems and methods herein can be applied to a variety of print management tasks. Exemplary applications include the following:
Corporate Environments: Implementing efficient print management systems in large organizations with diverse user bases and extensive printing needs;
Educational Institutions: Streamlining print job workflows in schools, colleges, and universities to manage high-volume printing across various departments and users;
Government Offices: Enhancing document control and resource allocation within government sectors where tracking and managing print activities are essential; Healthcare Facilities: Facilitating secure and accountable print workflows in hospitals and clinics, ensuring sensitive patient information remains confidential; and
Business Service Providers: Supporting managed print services for clients, optimizing print resources and promoting accountable print practices across industries.

Systems and methods of the invention provide a dynamic prompt system for managing print volume across large organizations. When a user attempts to initiate a print job, a customized C# message box can intercept the request across applications and devices. This message box prompts the user to justify the print job's purpose before allowing the print activity to proceed. This system ensures that print metadata is temporarily withheld until the user provides the necessary justification, after which the print job is released for execution.

In various embodiments, systems and methods of the invention may include dynamic prompt integration which involves the seamless integration of a C# message box that intercepts print job requests across various platforms and applications. Users can be presented with immediate prompts to provide justification for print jobs, ensuring accountability and visibility into print activities. An adaptive display can be used by the system that intelligently adapts to multi-monitor setups and Hosted Virtual Desktop (HVD) environments, displaying the prompt on the active screen where the user is working, regardless of device or workspace configuration.

An exemplary process according to certain embodiments can include a print request initiation wherein the user attempts to print a document from any application. A C# message box can then be activated wherein the dynamic message box intercepts the print job release. The message box can prompt the user to provide a reason for the print job. The print job metadata is withheld until the user justifies the print job. Upon justification, the print metadata can be released, allowing the print job to proceed.

In various embodiments, a service or process can be implemented that observes and waits for a print event trigger. For example, a daemon service can monitor the main printing folder for the creation of any new subfolders therein. The creation of a new subfolder will correspond to a new print job and, accordingly, the system can identify any new print requests. When the new print job is detected as a new subfolder, a service can add it to a work-in-progress list which contains all of the print jobs waiting for a user action. The daemon can remain running all the time in the background, constantly watching for new subfolders (new print jobs) and managing the work-in-progress and exclusion lists to ensure the process is smooth.

Below is an exemplary code for print folder monitoring:

```
  private void StartMonitoring( )
  {
    while (isMonitoring){
      string[ ] exclusionList = File.ReadAllLines(exclusionListFile);
      string[ ] subdirectories = Directory.GetDirectories(PrintJobFolder);
      // Filter out directories based on the exclusion pattern and list
      var filteredDirectories = subdirectories
        .Where(dir => !exclusionList.Contains(System.IO.Path.GetFileName(dir)))
        .Where(dir => !WIPJobListFile.Contains(System.IO.Path.GetFileName(dir)))
        .ToArray( );
      PrintLen = filteredDirectories.Count( );
      if (PrintLen > 0){
        foreach (string subFold in filteredDirectories){
          RegistryKey rKey;
          try{
            Registry.CurrentUser.CreateSubKey(@“Software\\GreenInitiative”);
          }
          catch (Exception ex){//Do Nothing
          }
          finally{
            rKey =
Registry.CurrentUser.OpenSubKey(@“Software\\GreenInitiative”, true);
            rKey.SetValue(“FirstPrint”, subFold);
          }
        }
        ShowUI( ); //Display the Justification UI for user
        isMonitoring = false;
      }
      System.Threading.Thread.Sleep(1000); // Wait for 0.5 second before checking
again
    }
}
```

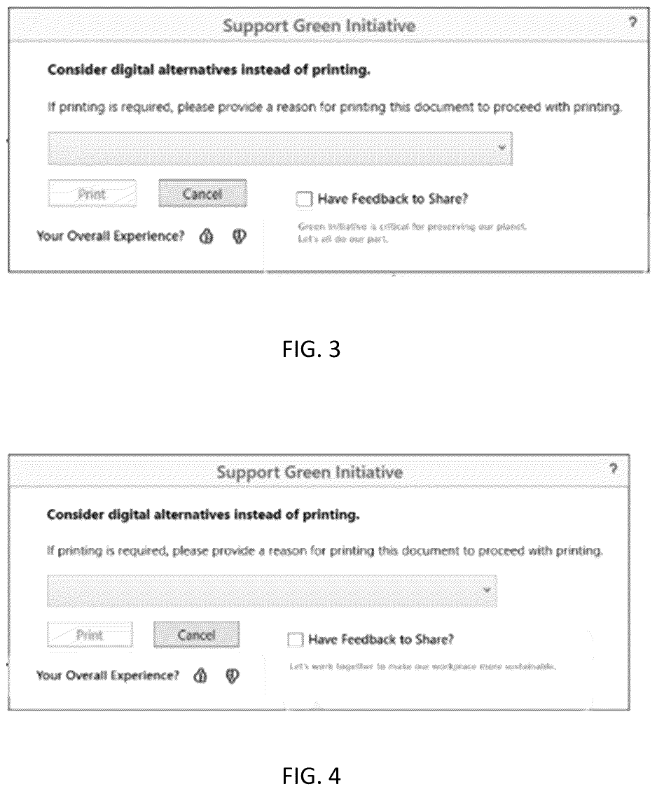

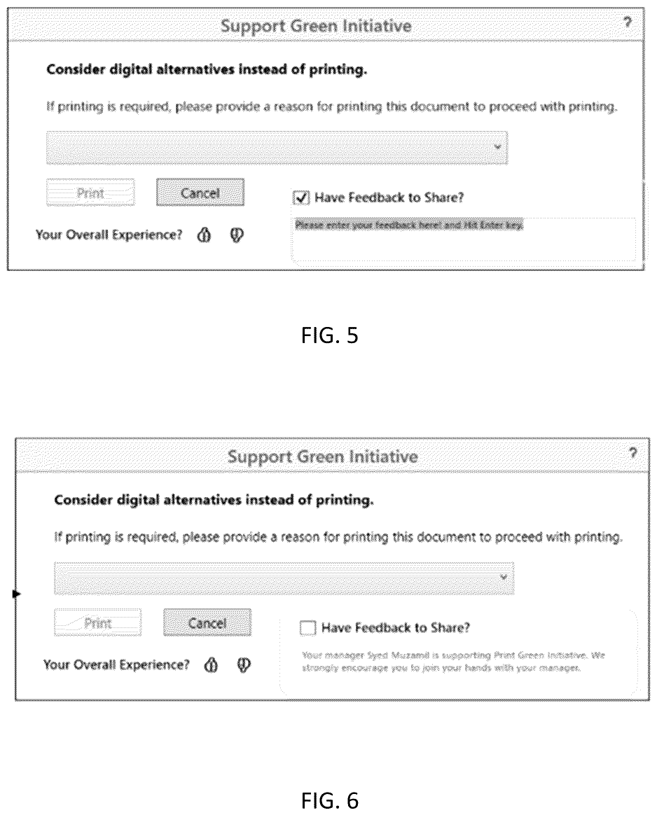

Upon the print job's initial release from any disparate application, a message box such as the one depicted in FIG. 3 can be displayed. The message box can display a message explaining the green initiative, cost reduction, or other reasoning behind the justification request or print logging. The dynamic message box can prompt the user to select a reason for the print with a pre-defined dropdown option to choose from. In some embodiments, the user may enter a freeform text justification. The message box can display an encouraging message as shown in FIG. 3 in various embodiments to encourage users to comply with the initiative. The message box can provide a feedback loop wherein the message box allows the provision of feedback as shown in FIG. 4. The message box can allow feedback with a simple thumbs up or down and/or an optional text box for the user to provide more detailed, personalized feedback. Users can send the feedback by entering it in the text box and checking a checkbox as shown in FIG. 5. Natural language processing (NLP) can be used to analyze the feedback. The custom feedback can be stored in a central database NLP can be used to identify the message as positive, negative, or neutral by, for example, assigning a polarity score.

Once the user has justified the print job, the tool or service can move the print job back to the main print folder to continue on with printing. In various embodiments, the service can also add the job to an exclusion list which ensure that the tool doesn't ask for a justification for the same print job again, even if there's a delay in physically printing the document (e.g., the Print/Submit button on the Printer to release or start printing the paper). In order to do so, for jobs that are already on the Exclusion List (e.g., justified but not picked up yet), the service knows to ignore them and not show pop-up message-box again because it cross-checks all jobs against the exclusion list.

A polarity score module (e.g., VaderSharp) can provide a sentiment classification for the message. The immediate team members of the user can be identified and the closest peer or superior within the organization who has provided positive feedback can be identified and that feedback can be relayed in the message box as shown in FIG. 6 to encourage the user to comply with the initiative.

The following is exemplary code for implementing the sentiment analysis of feedback by polarity score:

using VaderSharp;
var analyzer = new SentimentIntensityAnalyzer( );
var sentiment = analyzer.PolarityScores(userfeedMsg.Text);
if (sentiment.Compound >= 0.05)
{
User Sentiment = “Positive”;
}
else if (sentiment.Compound <= −0.05)
{
User Sentiment = “Negative”;
}
else
{
User Sentiment = “Neutral”;
}

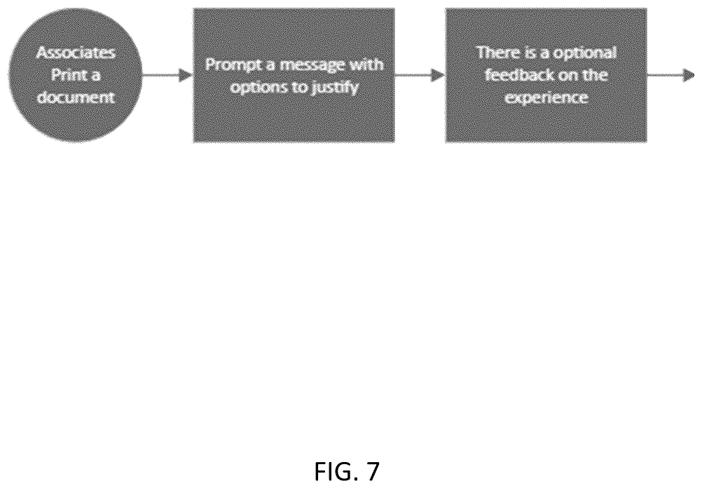

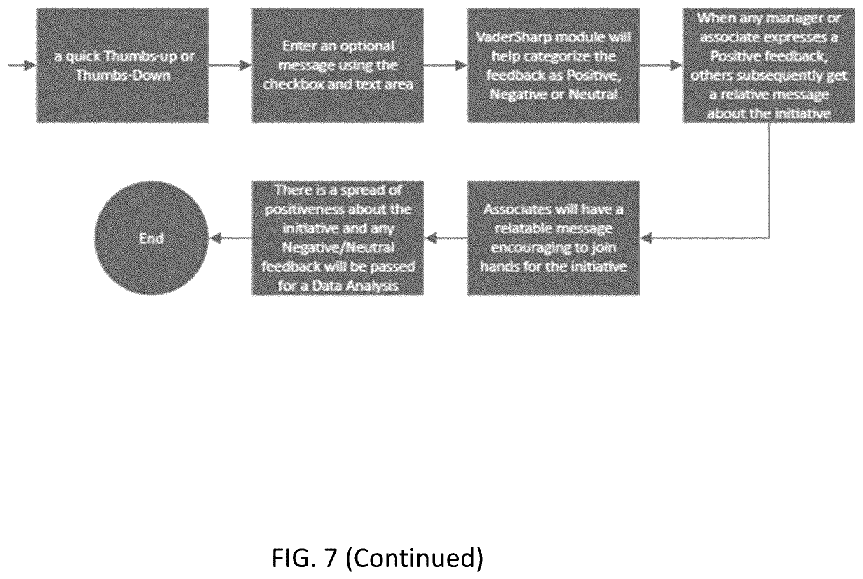

FIG. 7 shows an exemplary flow chart of methods of the invention according to certain embodiments. An associate prints a document which triggers a message with options to provide justification for the print job. The associate is provided an option to provide feedback which can consist of a binary positive or negative feedback (e.g., a thumbs up or down). The associate may also enter optional feedback messages using a check box and text area. NLP analysis of the text feedback can categorize the feedback as positive, negative, or neutral. If positive feedback is received, that feedback can be stored for subsequent display, along with associate identification, to the associate's peers to encourage participation.

In various embodiments, if analyzed feedback is determined to be negative, the user that has provided the negative feedback may be exempted from print justifications for a selected number of print requests (e.g., 5 or 10). Thereby systems and methods of the invention can avoid negatively impacting employee sentiment and encourage buy in to initiatives. In some embodiments, users that have provided previous positive feedback may be encouraged or thanked in subsequent print justification prompts to encourage continued compliance.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for print management, the method comprising:
receiving, from a client computing device, an electronic print request comprising print metadata from a user;
withholding the print metadata from a printer;
requesting, from the client computing device, a justification for the print request;
receiving, from the client computing device, the requested justification; and
releasing the print metadata to the printer to initiate printing of the print request after receiving the requested justification.

2. The computerized method of claim 1, wherein the requesting step comprises displaying a prompt on the user's computer monitor.

3. The computerized method of claim 2, further comprising detecting an active monitor in a multi-monitor environment of the user and displaying the prompt on the active monitor.

4. The computerized method of claim 3, wherein the multi-monitor environment comprises a hosted virtual desktop (HVD) session further comprising displaying the prompt within in the HVD session.

5. The computerized method of claim 1, further comprising storing the received justification in a database for analysis.

6. The computerized method of claim 2, wherein the prompt comprises a list of pre-filled justifications for the user to select.

7. The computerized method of claim 2, wherein the prompt further comprises a request for feedback from the user, the method further comprising receiving feedback from the user and analyzing the received feedback with natural language processing to assign a sentiment to the received feedback selected from positive, negative, or neutral.

8. The computerized method of claim 7, wherein the prompt further comprises a promotional message identifying a second user that has shared positive feedback.

9. The computerized method of claim 8, further comprising identifying the second user based on an organizational relationship with the user.

10. The computerized method of claim of claim 7, wherein the received feedback is assigned a negative sentiment, the method further comprising pausing justification requests of the user for a selected number of print requests received from the user.

11. A computer system for print management, the system comprising a processor in communication with a non-transient memory and operable to perform the steps of:
receiving, from a client computing device, a print request comprising print metadata from a user;
withholding the print metadata from a printer;
requesting, from the client computing device, a justification for the print request;
receiving, from the client computing device, the requested justification; and
releasing the print metadata to the printer to initiate printing of the print request after receiving the requested justification.

12. The computerized system of claim 11, wherein the requesting step comprises displaying a prompt on the user's computer monitor.

13. The computerized system of claim 12, further operable to detect an active monitor in a multi-monitor environment of the user and display the prompt on the active monitor.

14. The computerized system of claim 13, wherein the multi-monitor environment comprises a hosted virtual desktop (HVD) session, the system further operable to display the prompt within in the HVD session.

15. The computerized system of claim 11, further operable to store the received justification in a database for analysis.

16. The computerized system of claim 12, wherein the prompt comprises a list of pre-filled justifications for the user to select.

17. The computerized system of claim 12, wherein the prompt further comprises a request for feedback from the user, the system further operable to receive feedback from the user and analyze the received feedback with natural language processing to assign a sentiment to the received feedback selected from positive, negative, or neutral.

18. The computerized system of claim 17, wherein the prompt further comprises a promotional message identifying a second user that has shared positive feedback to promote compliance.

19. The computerized system of claim 18, further operable to identify the second user based on an organizational relationship with the user.

20. The computerized system of claim 17, wherein the received feedback is assigned a negative sentiment, the system further operable to pause justification requests of the user for a selected number of subsequent print requests received from the user.
